(19) United States
(12) Patent Application Publication
(10) Pub. No.: US 2020/0090110 A1
(43) Pub. Date: Mar. 19, 2020

(54) SYSTEM AND METHOD FOR COGNITIVE AND PREEMPTIVE FASHION INVENTORY MANAGEMENT & ORDER FULFILMENT

(71) Applicant: International Business Machines Corporation, Armonk, NY (US)

(72) Inventors: Mohit Sewak, Lucknow (IN); PratikKumar Fadadu, Bangalore (IN)

(21) Appl. No.: 16/132,867

(22) Filed: Sep. 17, 2018

(51) Int. Cl. G06Q 10/08; G06Q 30/02; G06N 5/04; G06N 3/08; G06F 15/18

(52) U.S. Cl. CPC G06Q 10/087; G06Q 30/0202; G06F 15/18; G06N 3/08; G06N 5/046

(57) ABSTRACT

A method, computer program product, and computing system are provided for receiving a plurality of customer data for a plurality of retail spaces. A plurality of fashion-ability scores representative of a plurality of fashion products may be generated. An order for shipment of at least a subset of the plurality of fashion products to at least a subset of the plurality of retail spaces may be generated based upon, at least in part, the plurality of customer data and the plurality of fashion-ability scores.

### BACKGROUND

Item by item, or online order fulfilment is generally very costly as the pricing for delivering a particular item from a remote location immediately (or on demand) has different shipping rates and/or requires different modes of transportation when compared to bulk movement of inventory across a location in a planned manner and at a pre-planned date/time. However, such pre-planning may delay order fulfilment and as a result, may lower customer satisfaction, leading to churn.

### BRIEF SUMMARY OF DISCLOSURE

In one example implementation, a computer-implemented method is executed on a computing device and may include but is not limited to receiving, on a computing device, a plurality of customer data for a plurality of retail spaces. A plurality of fashion-ability scores representative of a plurality of fashion products may be generated. An order for shipment of at least a subset of the plurality of fashion products to at least a subset of the plurality of retail spaces may be generated based upon, at least in part, the plurality of customer data and the plurality of fashion-ability scores.

One or more of the following example features may be included. A fashion demand for at least one retail space of the plurality of retail spaces may be defined based upon, at least in part, the customer data and the plurality of fashion-ability scores. The at least a subset of the plurality of fashion products may be associated with a future fashion impact event. An order for shipment of the at least a subset of the plurality of fashion products associated with the future fashion impact event to the at least a subset of the plurality of retail spaces may be generated based upon, at least in part, the future fashion impact event. Generating the order for shipment of the at least a subset of the plurality of fashion products may include generating one or more optimization models. The one or more optimization models may be configured to optimize the shipment of the at least a subset of the plurality of fashion products to the at least a subset of the plurality of retail spaces based upon, at least in part, one or more of a minimum shipping cost, a minimum transfer cost, and a minimum markdown cost. A plurality of customer segments may be defined based upon, at least in part, the plurality of customer data. A subset of fashion products may be associated with a first customer segment and a first retail space for a first time period based upon, at least in part, the plurality of customer data and the plurality of fashion-ability scores. A subset of fashion products may be associated with a first customer segment and a first retail space for a first time period based upon, at least in part, the plurality of customer data and the plurality of fashion-ability scores. An order to redistribute the subset of fashion products from the first retail space to the second retail space after the first time period may be generated.

In another example implementation, a computer program product resides on a computer readable medium that has a plurality of instructions stored on it. When executed across one or more processors, the plurality of instructions cause at least a portion of the one or more processors to perform operations that may include but are not limited to receiving a plurality of customer data for a plurality of retail spaces. A plurality of fashion-ability scores representative of a plurality of fashion products may be generated. An order for shipment of at least a subset of the plurality of fashion products to at least a subset of the plurality of retail spaces may be generated based upon, at least in part, the plurality of customer data and the plurality of fashion-ability scores.

One or more of the following example features may be included. A fashion demand for at least one retail space of the plurality of retail spaces may be defined based upon, at least in part, the customer data and the plurality of fashion-ability scores. The at least a subset of the plurality of fashion products may be associated with a future fashion impact event. An order for shipment of the at least a subset of the plurality of fashion products associated with the future fashion impact event to the at least a subset of the plurality of retail spaces may be generated based upon, at least in part, the future fashion impact event. Generating the order for shipment of the at least a subset of the plurality of fashion products may include generating one or more optimization models. The one or more optimization models may be configured to optimize the shipment of the at least a subset of the plurality of fashion products to the at least a subset of the plurality of retail spaces based upon, at least in part, one or more of a minimum shipping cost, a minimum transfer cost, and a minimum markdown cost. A plurality of customer segments may be defined based upon, at least in part, the plurality of customer data. A subset of fashion products may be associated with a first customer segment and a first retail space for a first time period based upon, at least in part, the plurality of customer data and the plurality of fashion-ability scores. A subset of fashion products may be associated with a first customer segment and a first retail space for a first time period based upon, at least in part, the plurality of customer data and the plurality of fashion-ability scores. An order to redistribute the subset of fashion products from the first retail space to the second retail space after the first time period may be generated.

In another example implementation, a computing system comprising one or more processors and one or more memories, wherein the computing system is configured to perform operations that may include but are not limited to receiving a plurality of customer data for a plurality of retail spaces. A plurality of fashion-ability scores representative of a plurality of fashion products may be generated. An order for shipment of at least a subset of the plurality of fashion products to at least a subset of the plurality of retail spaces may be generated based upon, at least in part, the plurality of customer data and the plurality of fashion-ability scores.

One or more of the following example features may be included. A fashion demand for at least one retail space of the plurality of retail spaces may be defined based upon, at least in part, the customer data and the plurality of fashion-ability scores. The at least a subset of the plurality of fashion products may be associated with a future fashion impact event. An order for shipment of the at least a subset of the plurality of fashion products associated with the future fashion impact event to the at least a subset of the plurality of retail spaces may be generated based upon, at least in part, the future fashion impact event. Generating the order for shipment of the at least a subset of the plurality of fashion products may include generating one or more optimization models. The one or more optimization models may be configured to optimize the shipment of the at least a subset of the plurality of fashion products to the at least a subset of the plurality of retail spaces based upon, at least in part, one or more of a minimum shipping cost, a minimum transfer cost, and a minimum markdown cost. A plurality of customer segments may be defined based upon, at least in part, the plurality of customer data. A subset of fashion products may be associated with a first customer segment and a first retail space for a first time period based upon, at least in part, the plurality of customer data and the plurality of fashion-ability scores. A subset of fashion products may be associated with a first customer segment and a first retail space for a first time period based upon, at least in part, the plurality of customer data and the plurality of fashion-ability scores. An order to redistribute the subset of fashion products from the first retail space to the second retail space after the first time period may be generated.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE SEVERAL VIEWS OF THE DRAWINGS

FIG. 1 is an example diagrammatic view of a cognitive fashion inventory process coupled to a distributed computing network according to one or more example embodiments of the disclosure;

FIG. 2 is an example flowchart of the cognitive fashion inventory process of FIG. 1 according to one or more example embodiments of the disclosure;

FIG. 3 is an example diagrammatic view of a plurality of retail spaces and catchments according to one or more example embodiments of the disclosure;

FIG. 4 is an example flowchart of the cognitive fashion inventory process of FIG. 1 according to one or more example embodiments of the disclosure;

FIG. 5 is an example diagrammatic view of the processing of images to generate one or more fashion-ability tensors and the generation of one or more fashion-ability scores representative of one or more fashion products according to one or more example embodiments of the disclosure;

FIGS. 6-8 are example flowcharts of the cognitive fashion inventory process of FIG. 1 according to one or more example embodiments of the disclosure;

FIGS. 9-10 are example diagrammatic views of a plurality of retail spaces and catchments according to one or more example embodiments of the disclosure; and

FIG. 11 is an example diagrammatic view of a client electronic device of FIG. 1 according to one or more example embodiments of the disclosure.

Like reference symbols in the various drawings indicate like elements.

### DETAILED DESCRIPTION

As will be discussed in greater detail below, embodiments of the present disclosure may improve distributed order management (DOM) systems. As known in the art, a DOM system may generally include a system or software with applications designed to intelligently arrange orders across the multiple systems by providing a single, global view of all inventory and retail spaces of a business. As will be discussed in greater detail below, cognitive fashion inventory process 10 may allow a DOM system to provide pre-emptive order fulfilment and inventory management as opposed to reactive order management in conventional DOM systems.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

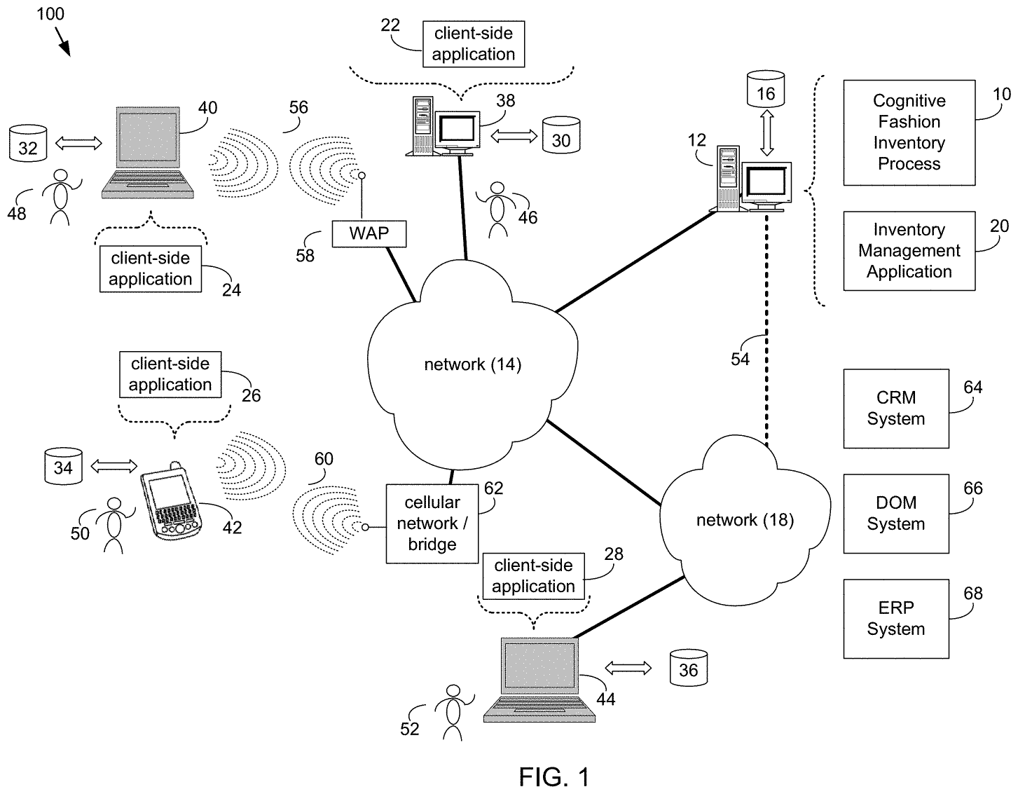

Referring now to FIG. 1, there is shown cognitive fashion inventory process 10 that may reside on and may be executed by a computing device 12, which may be connected to a network (e.g., network 14) (e.g., the internet or a local area network). Examples of computing device 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computing device 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, a cognitive fashion inventory process, such as cognitive fashion inventory process 10 of FIG. 1, may receive a plurality of customer data for a plurality of retail spaces. A plurality of fashion-ability scores representative of a plurality of fashion products may be generated. An order for shipment of at least a subset of the plurality of fashion products to at least a subset of the plurality of retail spaces may be generated based upon, at least in part, the plurality of customer data and the plurality of fashion-ability scores.

The instruction sets and subroutines of cognitive fashion inventory process 10, which may be stored on storage device 16 coupled to computing device 12, may be executed by one or more processors (not shown) and one or more memory architectures (not shown) included within computing device 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Cognitive fashion inventory process 10 may be a stand-alone application that interfaces with an applet/application that is accessed via client applications 22, 24, 26, 28. In some embodiments, cognitive fashion inventory process 10 may be, in whole or in part, distributed in a cloud computing topology. In this way, computing device 12 and storage device 16 may refer to multiple devices, which may also be distributed throughout network 14 and/or network 18.

Computing device 12 may execute an inventory management application (e.g., inventory management application 20), examples of which may include, but are not limited to, applications, portals, programs, and/or websites that facilitate inventory management and order fulfilment within a retail space. For example, IBM® Web Sphere® Commerce is a software platform framework for e-commerce, including marketing, sales, customer and order processing functionality in a tailorable, integrated package and may be an example of inventory management application 20. Additionally, IBM Watson Commerce Insights and IBM Management Center may be used as inventory management applications within the scope of the present disclosure. Cognitive fashion inventory process 10 and/or inventory management application 20 may be accessed via client applications 22, 24, 26, 28. Cognitive fashion inventory process 10 may be a stand-alone application, or may be an applet/application/script/extension that may interact with and/or be executed within inventory management application 20, a component of inventory management application 20, and/or one or more of client applications 22, 24, 26, 28. Inventory management application 20 may be a stand-alone application, or may be an applet/application/script/extension that may interact with and/or be executed within cognitive fashion inventory process 10, a component of cognitive fashion inventory process 10, and/or one or more of client applications 22, 24, 26, 28. One or more of client applications 22, 24, 26, 28 may be a stand-alone application, or may be an applet/application/script/extension that may interact with and/or be executed within and/or be a component of cognitive fashion inventory process 10 and/or inventory management application 20. Examples of client applications 22, 24, 26, 28 may include, but are not limited to, applications that receive queries to search for content from one or more databases, servers, cloud storage servers, etc., a textual and/or a graphical user interface, a standard web browser, a customized web browser, a plugin, an Application Programming Interface (API), or a custom application. The instruction sets and subroutines of client applications 22, 24, 26, 28 which may be stored on storage devices 30, 32, 34, 36 coupled to client electronic devices 38, 40, 42, 44 may be executed by one or more processors (not shown) and one or more memory architectures (not shown) incorporated into client electronic devices 38, 40, 42, 44.

Storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computing device 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Microsoft® Windows®; Mac® OS X®; Red Hat® Linux®, Windows® Mobile, Chrome OS, Blackberry OS, Fire OS, or a custom operating system.

One or more of client applications 22, 24, 26, 28 may be configured to effectuate some or all of the functionality of cognitive fashion inventory process 10 (and vice versa). Accordingly, cognitive fashion inventory process 10 may be a purely server-side application, a purely client-side application, or a hybrid server-side/client-side application that is cooperatively executed by one or more of client applications 22, 24, 26, 28 and/or cognitive fashion inventory process 10.

One or more of client applications 22, 24, 26, 28 may be configured to effectuate some or all of the functionality of inventory management application 20 (and vice versa). Accordingly, inventory management application 20 may be a purely server-side application, a purely client-side application, or a hybrid server-side/client-side application that is cooperatively executed by one or more of client applications 22, 24, 26, 28 and/or inventory management application 20. As one or more of client applications 22, 24, 26, 28 cognitive fashion inventory process 10, and inventory management application 20, taken singly or in any combination, may effectuate some or all of the same functionality, any description of effectuating such functionality via one or more of client applications 22, 24, 26, 28 cognitive fashion inventory process 10, inventory management application 20, or combination thereof, and any described interaction(s) between one or more of client applications 22, 24, 26, 28 cognitive fashion inventory process 10, inventory management application 20, or combination thereof to effectuate such functionality, should be taken as an example only and not to limit the scope of the disclosure.

Users 46, 48, 50, 52 may access computing device 12 and cognitive fashion inventory process 10 (e.g., using one or more of client electronic devices 38, 40, 42, 44) directly or indirectly through network 14 or through secondary network 18. Further, computing device 12 may be connected to network 14 through secondary network 18, as illustrated with phantom link line 54. Cognitive fashion inventory process 10 may include one or more user interfaces, such as browsers and textual or graphical user interfaces, through which users 46, 48, 50, 52 may access cognitive fashion inventory process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 800.11a, 800.11b, 800.11g, Wi-Fi®, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 800.11x specifications may use Ethernet protocol and carrier sense multiple access with collision avoidance (i.e., CSMA/CA) for path sharing. The various 800.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

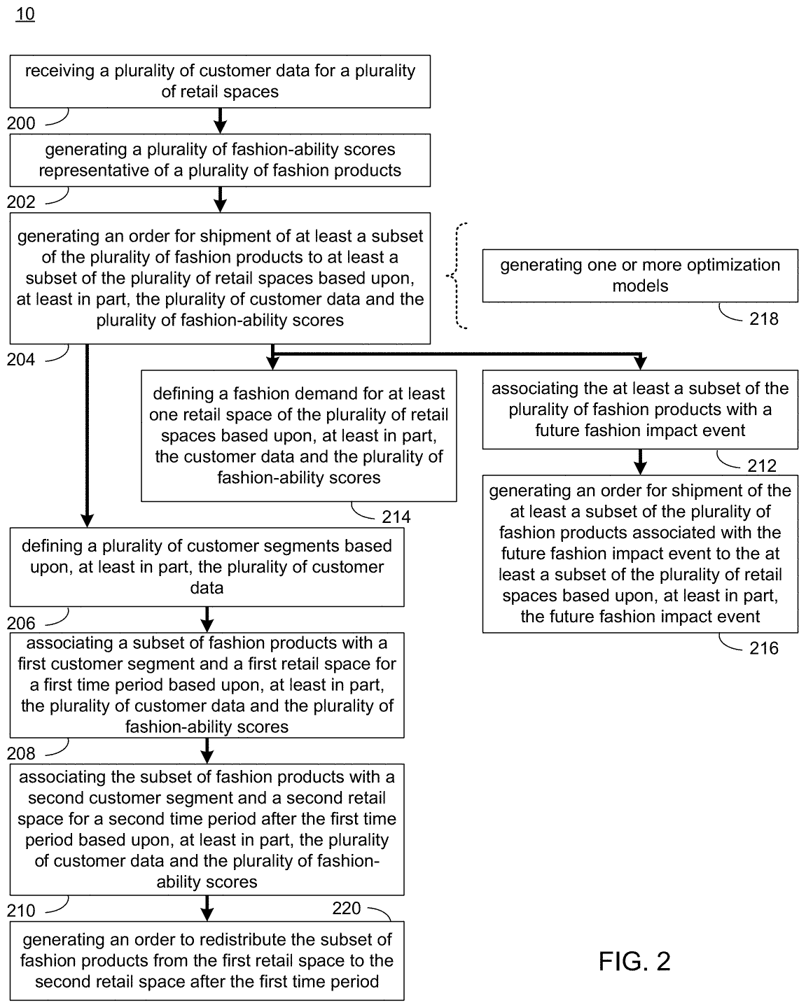

As discussed above and referring also at least to FIGS. 2-11, cognitive fashion inventory process 10 may receive 200, on a computing device, a plurality of customer data for a plurality of retail spaces. A plurality of fashion-ability scores representative of a plurality of fashion products may be generated 202. An order for shipment of at least a subset of the plurality of fashion products to at least a subset of the plurality of retail spaces may be generated 204 based upon, at least in part, the plurality of customer data and the plurality of fashion-ability scores.

In some embodiments consistent with the present disclosure, systems and methods may be provided for cognitive fashion inventory management and order fulfilment. Specifically, cognitive fashion inventory process 10 may provide inventory management and order fulfilment for a plurality of retail spaces based upon, at least in part, a plurality of customer data for a plurality of retail spaces and computer vision capacities configured to define fashion-ability scores for a plurality of fashion products.

As discussed above, item by item, or online order fulfilment is generally very costly as the pricing for delivering a particular item from a remote location immediately (or on demand) has different shipping rates and/or requires different modes of transportation when compared to bulk movement of inventory in a planned manner and at a pre-planned date/time. However, such pre-planning may delay order fulfilment and as a result, may lower customer satisfaction, leading to churn.

By pre-emptive fulfilment via embodiments of the present disclosure, it may be possible to optimize and/or improve on both fulfilment cost and fulfilment time. In addition, embodiments of the present disclosure may determine what products will likely be required and in which quantity. As will be discussed in greater detail below, pre-emptive fulfilment may be realized for fashion products. Fashion is a very dynamic concept, which leads to a lot of volatility in a fashion product's life cycle. For example, huge inventory buildup in a fashion product's lifecycle may be followed by markdowns towards the end of the fashion product's lifecycle. As fashion is significantly influenced by social, cultural, fashion-specific events, etc., predicting where and when to stock fashion products and in what quantities has proven difficult. Additionally, the ability to cognitively and automatically define fashion taste in a way similar to that of a customer may be necessary to know where to provide fashion products.

Embodiments of the present disclosure may also address challenges specific to fashion products where the trend of specific fashion products becomes stale with respect to a particular customer segment. In conventional fashion retail methodologies, this staleness is dealt with by either writing off direct losses and/or by heavily sacrificing profits in the form of steep markdowns. As will be discussed in greater detail below and in some embodiments of the present disclosure, cognitive fashion inventory process 10 may cognitively anticipate staleness in fashion trends and provide for the transfer of fashion products from a first retail space associated with a first customer segment to a second retail space associated with a second customer segment. In this example, cognitive fashion inventory process 10 may determine that the fashion products are now trendy to the second customer segment. In this manner, the above-described problems in conventional fashion product retail may be avoided and/or reduced by pre-emptively and efficiently predicting fashion product staleness and providing for the transfer of fashion products to another customer segment to whom the fashion product is now trendy. While fashion products have been discussed, it will be appreciated that other non-fashion products may be utilized within the scope of the present disclosure.

As will be discussed in greater detail below, embodiments of the present disclosure may improve distributed order management (DOM) systems. As known in the art, a DOM system may generally include a system or software with applications designed to intelligently arrange orders across the multiple systems by providing a single, global view of all inventory and retail spaces of a business. Embodiments of the present disclosure may work with different types of brick & mortar stores, online stores, and warehouses to coordinate the fulfilment and inventory across these channels. So an online order could also be fulfilled from a nearby store instead of a warehouse if the cost of doing so overwhelms the monetary value of (probability of event combined with loss given event) of stock-out from that store. As such, conventional DOM systems, which are unable to facilitate generating orders for shipments based upon, at least in part, the fashion-ability scores, may be improved to pre-emptively generate orders across various retail spaces for fashion products based upon, at least in part, the plurality of fashion-ability scores.

As will be discussed in greater detail below and in some embodiments, cognitive fashion inventory process 10 may generate pre-emptive orders for shipment and/or transfer of fashion products to and from retail spaces based upon, at least in part, cognitive and visual analytics associated with visual perceptions of fashion products defined as fashion-ability scores.

As generally discussed above with reference to FIGS. 2-4, cognitive fashion inventory process 10 may receive 200, on a computing device, a plurality of customer data for a plurality of retail spaces. Customer data may generally include customer purchase history, customer purchase trends, customer similarity (e.g., based on demographics), and/or customer location. In some implementations, the plurality of customer data may be received from a Customer Relationship Management (CRM) System. A CRM system may generally include a system or software with applications designed to help businesses or retail spaces manage business processes such as current customer data, customer interaction data, potential customer data, etc. For example, a CRM system (e.g., CRM system 64) may be configured to communicate and/or interface with cognitive fashion inventory process 10. In some implementations, cognitive fashion inventory process 10 may be configured to request customer data from a CRM system and receive 200 the plurality of customer data for a plurality of retail spaces in response to requesting the customer data from a CRM system. In some implementations, cognitive fashion inventory process 10 may interface with one or more CRM systems. While CRM systems have been described, it will be appreciated that a plurality of customer data may be received 200 from a plurality of sources.

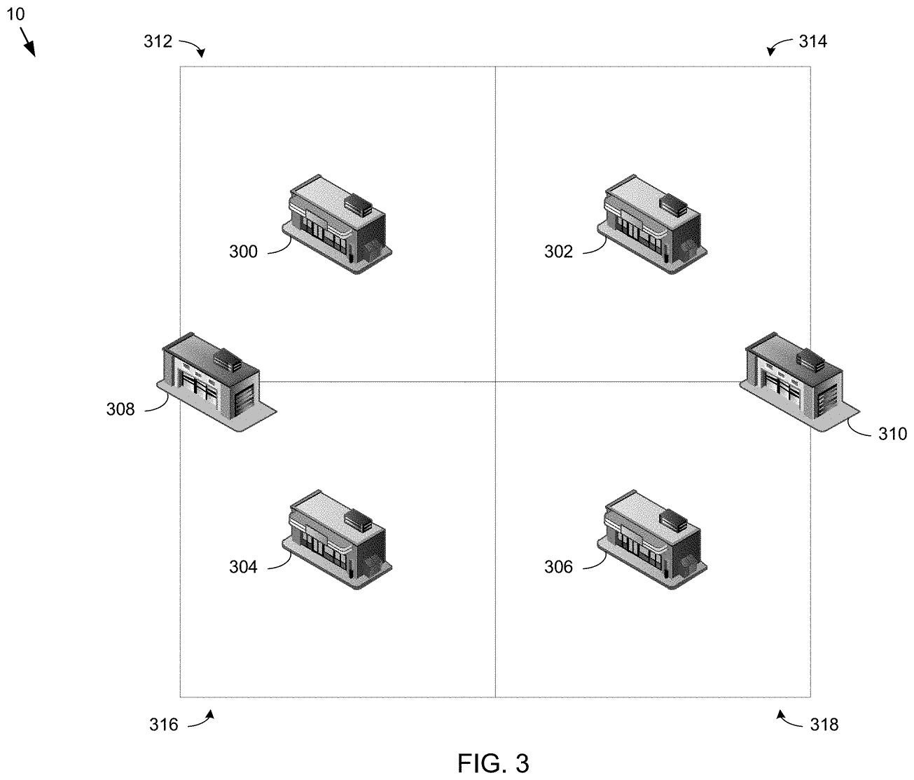

In some implementations, the plurality of customer data may be received for a plurality of retail spaces. Retail spaces may generally include facilities or locations where products may be stored and/or sold anywhere in the stream of commerce. Examples of retail spaces may include brick and mortar stores, online fulfilment centers, warehouses, etc. Referring also to the example of FIG. 3 and in some implementations, a plurality of retail spaces may include a plurality of brick and mortar stores (e.g., stores 300, 302, 304, 306) and a plurality of warehouses (e.g., 308, 310). While FIG. 3 describes an example with four retail stores and two warehouses, it will be appreciated that any number of retail spaces are possible within the scope of the present disclosure. As will be discussed in greater detail below, each retail space may be associated with at least a portion of customer data. For example, suppose a store (e.g., store 300) has a catchment defined for example purposes as in FIG. 3 as a square grid (e.g., catchment 312). This catchment may define a sphere of influence from which a retailer is likely to draw its customers. This may include a physical area proximate to a retail space from which customers are expected to come. In the example of FIG. 3, suppose retail spaces 300, 302, 304, 306 have catchments 312, 314, 316, 318, respectively. It will be appreciated that these square grids are drawn for example purposes only and that various shapes, overlapping spaces, etc. are possible in catchments of retail spaces. In some implementations, customer data may be received 200 regarding customers within the catchments (e.g., catchments 312, 314, 316, 318) for each retail space.

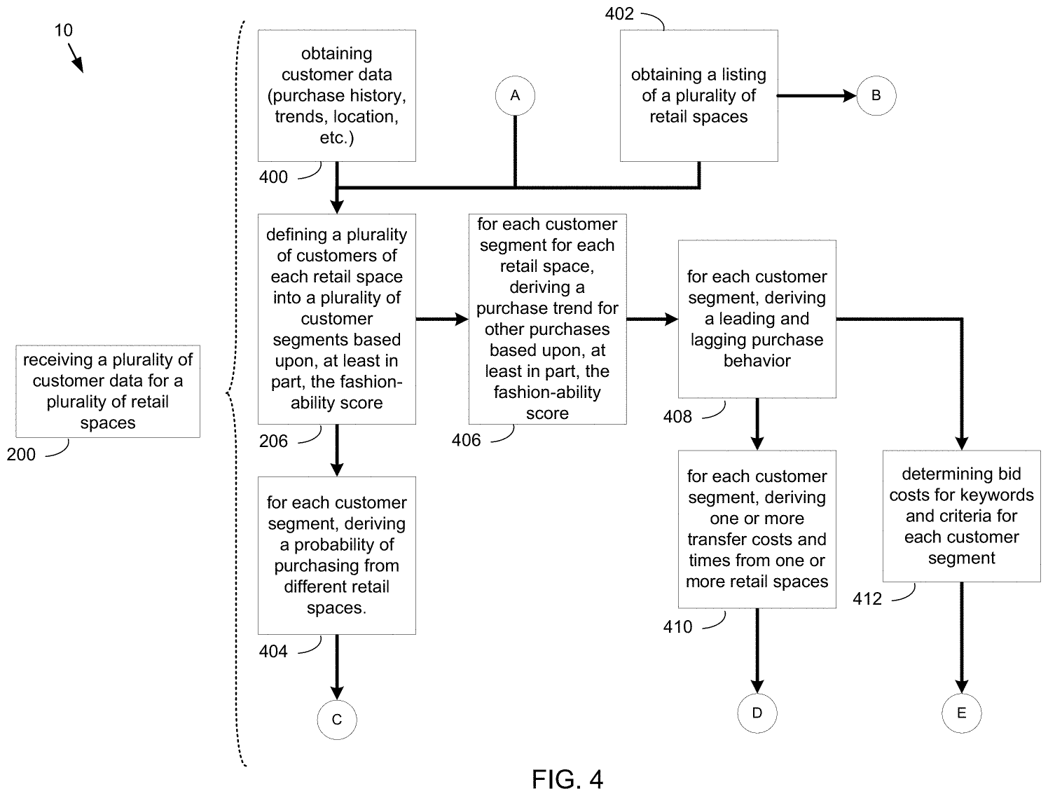

Referring also to the example of FIG. 4 and in some implementations, receiving 200 the plurality of customer data for a plurality of retail spaces may include obtaining 400 customer data (e.g., customer purchase trends, customer purchase history, customer location, etc.). As discussed above, the plurality of customer data may be received 200 from a CRM system (e.g., CRM system 64). In some implementations, cognitive fashion inventory process 10 may include obtaining 402 a listing of a plurality of retail spaces. For example, cognitive fashion inventory process 10 may receive the listing of the plurality of retail spaces from a Distributed Order Management (DOM) System. A DOM system may generally include a system or software with applications designed to intelligently arrange orders across the multiple systems by providing a single, global view of all inventory and retail spaces of a business. For example, a DOM system (e.g., DOM system 66) may be configured to communicate and/or interface with cognitive fashion inventory process 10. In some implementations, cognitive fashion inventory process 10 may be configured to request a listing of the plurality of retail spaces from a DOM system and obtain 402 the listing of retail spaces in response to the request made to the DOM system. In some implementations, cognitive fashion inventory process 10 may interface with and/or be integrated with one or more DOM systems. While DOM systems have been described, it will be appreciated that the listings of retail spaces may be obtained 402 from a plurality of sources.

In some implementations, cognitive fashion inventory process 10 may receive fashion product inventory data for the plurality of retail spaces. As discussed above and in some implementations, cognitive fashion inventory process 10 may interact with a DOM system or other systems such as an Enterprise Resource Planning (ERP) system (e.g., ERP system 68) to obtain or receive the fashion product inventory for the plurality of retail spaces. However, it will be appreciated that cognitive fashion inventory process 10 may interact with and/or may be integrated with various systems to determine the fashion product inventory for the plurality of retail spaces.

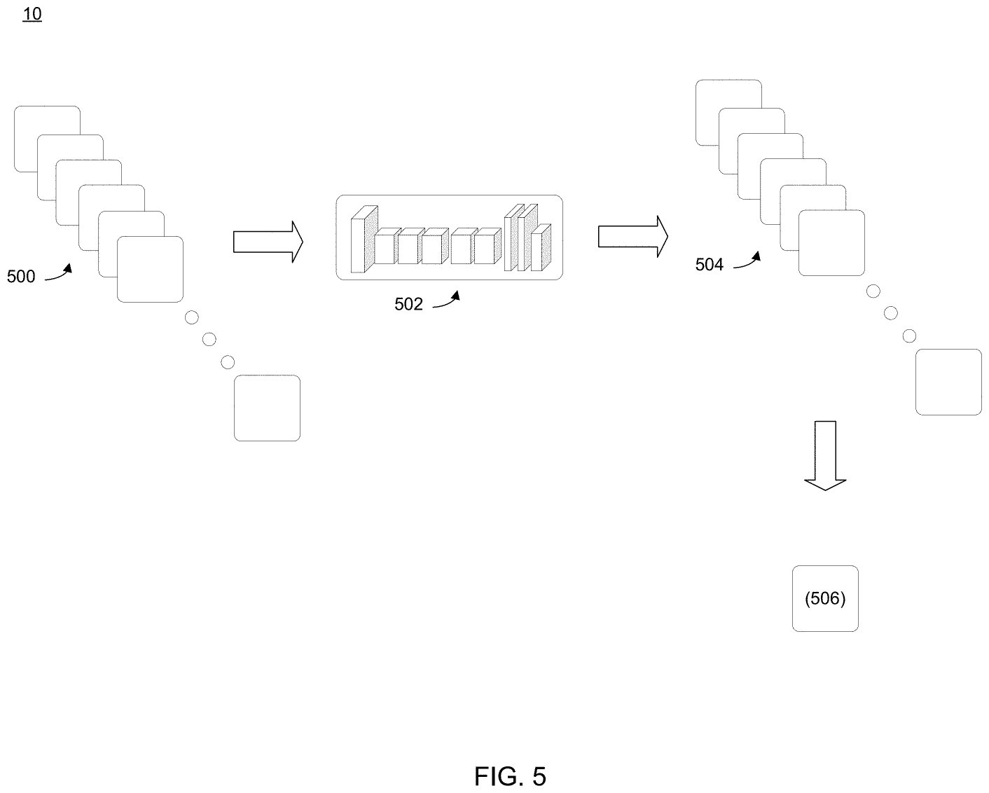

Referring also to FIGS. 5-7 and in some implementations, cognitive fashion inventory process 10 may generate 202 a plurality of fashion-ability scores representative of a plurality of fashion products. As discussed above and in some implementations, the plurality of products may include a plurality of fashion products. In some implementations, the cognitive and visual perception of customer may be modeled by cognitive fashion inventory process 10 as a fashion-ability score. In other words, a fashion-ability score may generally include a numerical representation of a fashion product defined for one or more attributes associated with the one or more fashion products. These fashion-ability scores may be generated by processing the image(s) of one or more fashion products using a neural network and by training the neural network with one or more attributes associated with the fashion product. For example and referring also to FIG. 5, cognitive fashion inventory process 10 may receive one or more images of one or more fashion products (e.g., images 500). The one or more images (e.g., images 500) may be digital representations displayed on a user interface and/or may be physical photographs or reproduction of photographs. In some embodiments, cognitive fashion inventory process 10 may receive the plurality of images (e.g., images 500) via a camera system. Additionally, the one or more images of the one or more fashion products (e.g., images 500) may be received from a computing device (e.g., client electronic devices 38, 40, 42, 44 (and/or computing device 12)). It will be appreciated that the one or more images of the one or more fashion products (e.g., images 500) may be received in various ways within the scope of the present disclosure. In some embodiments, the one or more images (e.g., images 500) may be stored in a repository or other database for processing.

In some embodiments, cognitive fashion inventory process 10 may receive metadata associated with the one or more images. For example, for each image, cognitive fashion inventory process 10 may receive metadata corresponding to different characteristics or attributes of the one or more images of the one or more fashion products. In some embodiments, metadata may be visual or non-visual (e.g., tags, features extracted from description, brand, color, price, price history, discounts, etc.) Examples of the metadata associated with the one or more images may include, but is not limited to, categories of the one or more fashion products, materials of the one or more fashion products, patterns of the one or more fashion products, age groups associated with the one or more fashion products, gender associated with the one or more fashion products, price associated with the one or more fashion products, the trendiness of the one or more fashion products, the highest year trending of the one or more fashion products, the number of social media likes associated with the one or more fashion products, survey responses associated with one or more fashion products, etc. As will be discussed in greater detail below, the metadata associated with the one or more images may be used as a training classification or attribute when processing the one or more images by cognitive fashion inventory process 10. In some embodiments, the metadata may be categorical (e.g., movies or television programs in which this fashion product appeared), continuous (e.g., price of fashion product), and/or a combination of categorical and continuous (e.g., price perception by age).

In some embodiments, cognitive fashion inventory process 10 may define one or more categories associated with the one or more fashion products based upon, at least in part, the one or more images (e.g., images 500) and the metadata associated with the one or more images. For example, cognitive fashion inventory process 10 may define categories associated with the one or more fashion products to include categories such as outerwear, innerwear, coats, jackets, hats, scarves, dresses, shoes, socks, shirts, blouses, pants, skirts, ties, suits, etc. based upon the one or more images and the metadata associated with the one or more images. While several possible categories for the one or more fashion products have been provided, it will be appreciated that other categories are possible within the scope of the present disclosure. In some embodiments, cognitive fashion inventory process 10 may define one or more sub-categories for the one or more categories. For example, cognitive fashion inventory process 10 may define sub-categories associated with the category the “shirts” category to include men's shirts, women's shirts, boy's shirts, girl's shirts, t-shirts, novelty t-shirts, long-sleeve shirts, sleeveless shirts, workout shirts, swimming shirts, etc. While several possible sub-categories for the “shirts” category have been provided, it will be appreciated that other sub-categories are possible within the scope of the present disclosure for various categories defined for the one or more fashion products.

In some embodiments, cognitive fashion inventory process 10 may process the one or more of images of the one or more fashion products (e.g., images 500) to generate one or more fashion-ability tensors. In some embodiments, cognitive fashion inventory process 10 may process the one or more images (e.g., images 500) using a neural network. For example, cognitive fashion inventory process 10 may receive the one or more images (e.g., images 500) and may process the one or more images via a neural network (e.g., neural network 502). A neural network may generally include a computing system that “learns” to do tasks by processing examples. In some embodiments, a neural network is able to differentiate images from one another by analyzing a plurality of example images across one or more attributes. From this “training” with pre-identified images, a neural network (e.g., neural network 502) is able to generally identify a similar image and/or differentiate an image against other images for a given attribute or dimension. For example and as discussed above, metadata associated with the one or more images may be used as attributes or dimensions to train the one or more images on the neural network (e.g., neural network 502) of cognitive fashion inventory process 10. Additional details regarding neural networks are described, for example, in Sewak, M., Md, Karim, R., & Pujaru, P. (2018). Practical Convolutional Neural Networks. (pp. 91-113). Birmingham, UK: Packt Publishing., which is incorporated herein by reference.

In some embodiments, processing the one or more images of the one or more fashion products may include selecting one or more images to process via the neural network (e.g., neural network 502). For example, cognitive fashion inventory process 10 may receive some training data (e.g., one or more images of the one or more fashion products) and test and validation data (e.g., one or more examples images of one or more fashion products). In some embodiments, the selection of which images to process may be automatic and/or may be defined manually by a user (e.g., using a user interface). In some embodiments, the selection of training data may be based upon, at least in part, the one or more categories and/or one or more sub-categories defined for the one or more fashion products shown in the one or more images. For example, certain models or types of neural network (e.g., neural network 502) may perform better (e.g., more discrete classification of images) for certain categories and/or sub-categories of fashion products. In experiments conducted by the Applicant, the model architecture or type of neural network (e.g., neural network 502) that may best define fashion-ability scores for different categories and/or different sub-categories of fashion products may differ and hence one-size or one neural network model may not fit all categories and/or sub-categories of fashion products. In some embodiments, cognitive fashion inventory process 10 may provide the flexibility to cognitively identify and select the right artificial-intelligence methodology/topology/neural network (e.g., neural network 502) to process the one or more images of a particular category and/or sub-category of fashion product to generate the one or more fashion-ability scores.

In some embodiments, cognitive fashion inventory process 10 may include a repository or other data structure including one or more model architectures or types of neural networks (e.g., neural network 502) to process the one or more images of the one or more fashion products (e.g., images 500). Examples of models or types of neural networks may generally include VGG16 Model Architecture, GoogLeNet, LeNet, ResNet, Inception, Xception, etc. It will be appreciated that various models or types of neural networks (e.g., neural network 502) may be used within the scope of the present disclosure. For example, any neural network or other model architecture configured for deep learning may be used within the scope of the present disclosure to process the one or more images of the one or more fashion products.

In some embodiments, cognitive fashion inventory process 10 may select a model architecture or type of neural network (e.g., neural network 502) based upon, at least in part, the one or more categories and/or sub-categories of the one or more images of the one or more fashion products (e.g., images 500). In some embodiments, a model may be trained for each category and/or each sub-category. In some embodiments, cognitive fashion inventory process 10 may select one or more attributes to train the neural network (e.g., neural network 502) with. For example, a neural network (e.g., neural network 502) may be trained to differentiate one or more images from a particular category or sub-category across the selected attribute. An attribute selected for training a neural network may also be referred to as a dimension. Cognitive fashion inventory process 10 may train the selected model or type of neural network (e.g., neural network 502) with the one or more images of the one or more fashion products across the selected attribute. In some embodiments, cognitive fashion inventory process 10 may store the trained neural network in a repository or other data structure.

In some embodiments, cognitive fashion inventory process 10 may generate one or more fashion-ability tensors (e.g., fashion-ability tensors 504) representative of the one or more fashion products for various models or types of neural networks. For example, cognitive fashion inventory process 10 may retrieve each trained neural network and score each of the one or more images against every attribute or dimension that the neural network is trained for. In some embodiments, the scoring of each image may generate one or more scored vectors, where each vector corresponds to a particular attribute used to train the neural network. Cognitive fashion inventory process 10 may join each of the scored vectors for a particular fashion product or image of the fashion product to form a multi-dimensional vector or fashion-ability tensor (e.g., fashion-ability tensors 504) corresponding to the visual representation of the fashion product.

In some embodiments, cognitive fashion inventory process 10 may generate the one or more fashion-ability scores representative of the one or more fashion products by selecting an attribute or dimension for generating a fashion-ability score and retrieving the vector trained for the selected attribute from the fashion-ability tensor for the fashion product (e.g., fashion-ability tensors 504). In response to retrieving the vector trained for the selected attribute from the fashion-ability tensor for the fashion product (e.g., fashion-ability tensors 504), cognitive fashion inventory process 10 may produce a fashion-ability score (e.g., fashion-ability score 506) that represents a fashion product for the selected dimension. For example, cognitive fashion inventory process 10 may select one or more attributes to define a fashion-ability score (e.g., fashion-ability score 506) for (e.g., trendiness of a fashion product for a given age-group). Cognitive fashion inventory process 10 may retrieve the vector from the fashion-ability tensor (e.g., fashion-ability tensors 504) for e.g., trendiness for a given age group to generate the one or more fashion-ability scores (e.g., fashion-ability score 506) representative of the one or more fashion products for the selected attribute of e.g., trendiness of a fashion product for a given age-group. In some embodiments, the generated fashion-ability score for the one or more fashion products (e.g., fashion-ability score 506) may represent the e.g., trendiness of a fashion product for a given age-group as a score. For example and in some embodiments, a higher fashion-ability score (e.g., fashion-ability score 506) may indicate that a particular fashion product is e.g., more trendy among a given age-group and a lower fashion-ability score (e.g., fashion-ability score 506) may indicate that a particular fashion product is e.g., less trendy among the given age-group. While the example attribute of “trendiness of a fashion product for a given age-group” has been discussed, it will be appreciated that various attributes or combinations of attributes may be used to generate fashion-ability scores within the scope of the present disclosure.

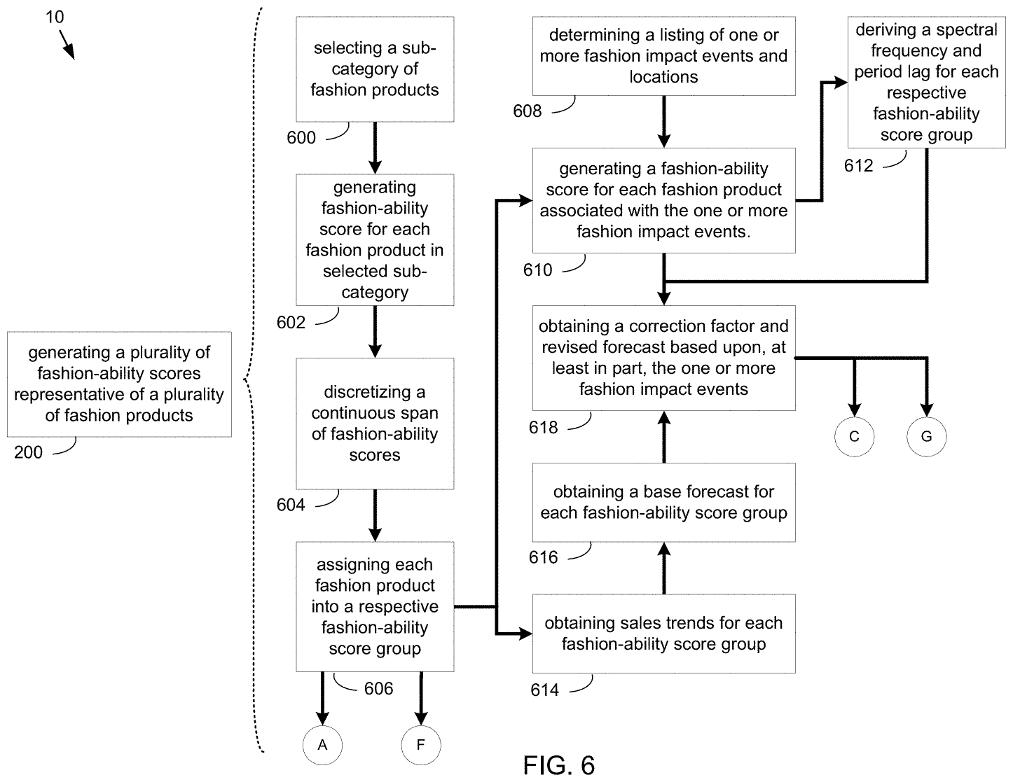

Referring also to FIG. 6, cognitive fashion inventory process 10 may select 600 a sub-category of fashion products. For example and as discussed above, a fashion-product may be associated with at least one category and/or sub-category. Cognitive fashion inventory process 10 may select a sub-category of fashion products from a catalogue or other source of fashion products to generate fashion-ability scores for. For example, cognitive fashion inventory process 10 may receive a plurality of images (e.g., images 500) for a plurality of fashion products. These images may be uploaded to cognitive fashion inventory process 10, may be accessed by interacting with an inventory system, an ERP system, a catalogue system, and/or any data structure configured to store images of fashion products that are and/or may be sold in the plurality of retail spaces. For example, suppose a user would like to determine where to ship or transfer fashion products to within a network of retail spaces. As will be discussed in greater detail below, by utilizing the fashion-ability scores of the fashion products to be sold at the plurality of retail spaces and the ability to associate customers in a given catchment of a retail space with the same fashion-ability score, cognitive fashion inventory process 10 may automatically and cognitively anticipate where to send fashion products. In this manner and as discussed above, cognitive fashion inventory process 10 may generate a plurality of fashion-ability scores for each product in the selected 602 sub-category of fashion products.

In some implementations, cognitive fashion inventory process 10 may discretize 604 a continuous span of fashion-ability scores. In some implementations, cognitive fashion inventory process 10 may assign 606 each fashion product of the plurality of fashion products into a respective fashion-ability score group. For example, suppose two women's dresses are available for purchase in a retail space and that the first fashion product has a fashion-ability score of e.g., 0.74 and that the second fashion product has a fashion-ability score of e.g., 0.7. Assume for example purposes only that cognitive fashion inventory process 10 is configured to assign 606 fashion products into respective fashion groups based upon, at least in part, the sub-category associated with the fashion product and the fashion-ability score. In this example, because both of the dresses are in the same sub-category (e.g., women's dresses) and within the same fashion-ability group threshold (e.g., a fashion-ability groups defined as 0.7-0.79), cognitive fashion inventory process 10 may assign 606 these two dresses into the same fashion-ability score group. While an example of dresses within a particular sub-category with a particular fashion-ability group has been described, it will be appreciated that various fashion products, sub-categories, and/or fashion-ability scores and ranges that define fashion-ability score groups are possible within the scope of the present disclosure.

Returning to the example of FIG. 4 and in response to obtaining 400 the customer data, assigning 606 each fashion product into a plurality of fashion-ability score groups, and/or obtaining 402 the listing of the plurality of retail spaces, cognitive fashion inventory process 10 may define 206 a plurality of customers of each retail space into a plurality of customer segments based upon, at least in part, the plurality of fashion-ability scores. A customer segment may generally include a representative sample of customers based upon, at least in part, the location of the customers and fashion-ability scores associated with the plurality of customers. For example, several customers may purchase fashion goods at a first retail space (e.g., store 300). As discussed above, a plurality of customer data for these customers may be received 200 by cognitive fashion inventory process 10. Within this customer data, the purchase history of the plurality of customers for this retail space may include fashion products purchased by these individuals at the retail space. In addition, the customer data may include an online purchase or fashion product browsing history on a website associated with the fashion products. The customer data may also define demographic characteristics that may influence fashion product purchasing behavior.

In some implementations, cognitive fashion inventory process 10 may analyze the customer data of the plurality of customers to associate a plurality of fashion products with each of the customers. For example, several customers who have purchased the same e.g., men's golf shirt may be associated with that men's golf shirt. While an example of a single men's golf shirt has been discussed, it will be appreciated that various numbers and types of fashion products may be associated with a customer. In some implementations and as discussed above, cognitive fashion inventory process 10 may generate a plurality of fashion-ability scores for the plurality of fashion products associated with the plurality of customers. In some implementations, a plurality of customers of a particular retail space may be defined or classified 206 into a customer segment based upon, at least in part, the fashion-ability scores of their associated fashion products. For example, the men's golf shirt may be associated with a fashion-ability score of e.g., 4.0. In some implementations, the catchment (i.e., customers of a retail space) may be classified 206 with respect to their fashion-ability score for each fashion sub-category. For example, customers associated with the same men's golf shirt may be associated with a fashion-ability score of e.g., 4.0. In some implementations, the customers may also be associated with a fashion-ability score of e.g., 4.0 for the sub-category of e.g., men's shirts.

Continuing with this example, the customers who purchased the e.g., men's golf shirt with a fashion-ability score of e.g., 4.0 from this retail space (e.g., store 300), may be classified into a customer segment for a fashion-ability score of 4.0. In some implementations, defining 206 customers into customer segments may be more or less granular, such as a customer segment of a fashion-ability score of e.g., 4.0 for the sub-category of e.g., men's shirts. In some implementations, the plurality of customer segments may include segments based upon sub-classes and/or sub-styles of fashion. For example, color, designs, fabric types, etc. may be used to define the plurality of customers into a plurality of customer segments. In some implementations, a given customer may be grouped into multiple segments proportionately such that the total contribution of the given customer is a single customer or “1”.

In some implementations and for each customer segment, cognitive fashion inventory process 10 may derive 404 a probability of purchasing fashion products from different retail spaces. For example, by deriving or determining the probability that a customer segment (e.g., customers of a given customer segment) will purchase fashion products from a different retail space, a more accurate inventory demand may be defined for the retail space. In some implementations, the probability may be a function of the distance from the retail space, nearest retail space footfall, socio-economic factors, propensity for online purchases, etc. As will be discussed in greater detail below, a higher probability that a particular customer segment may purchase fashion products from a different retail space or from online shopping may impact the quantity of fashion products to be ordered for each retail space.

In some implementations, cognitive fashion inventory process 10 may derive 406 a purchase trend for a plurality of other fashion products for each customer segment based upon, at least in part, the purchase history of the customer segment and the fashion-ability scores associated with the customer segment. For example, cognitive fashion inventory process 10 may derive or determine the purchase trend of other fashion products across various sub-categories of fashion products. In one example, cognitive fashion inventory process 10 may derive 408 or determine a purchase trend from the customer data to include purchases across different periods of time.

In some implementations, cognitive fashion inventory process 10 may derive 408 a leading and lagging purchase behavior for each customer segment to identify which customer segment follows the fashion from which other customer segment. For example and in some implementations, cognitive fashion inventory process 10 may associate 208 a subset of fashion products with a first customer segment and a first retail space for a first time period based upon, at least in part, the plurality of customer data and the plurality of fashion-ability scores. For example, suppose a first customer segment has a purchase history of purchasing fashion products with a fashion-ability score of e.g., 9.0 or greater for a first time period after the release of the fashion product. In some implementations, the first time period may be specific to each fashion product and may generally define the period of novelty or trendiness. In this example, a higher fashion-ability score may indicate a higher-end fashion product (i.e., an expensive, designer fashion product). However, it will be appreciated that any scale or range of fashion-ability scores may be used to indicate various attributes of a fashion product. After the expiry of the first time period, the novelty of the fashion product may subside as the product becomes more readily available to the public and/or less quality versions become available. As such, the fashion-ability score may change (e.g., change from 9.0 to 7.5) with the passage of time and/or with a change in the popularity of the fashion product.

In some implementations, cognitive fashion inventory process 10 may associate 210 the subset of fashion products with a second customer segment and a second retail space for a second time period after the first time period based upon, at least in part, the plurality of customer data and the plurality of fashion-ability scores. For example, cognitive fashion inventory process 10 may determine that a second customer segment has a purchase history of purchasing fashion products with a fashion-ability score of e.g., 7.5. In some implementations, this second customer segment may have a purchase history of purchasing fashion objects following the expiry of the first time period and/or of purchasing fashion products previously purchased by the first customer segment. In other words, the first customer segment may be trend-setters and the second customer segment may follow such trends. As such, the second customer segment may be associated with plurality of fashion objects for a second time period following the first time period. In some implementations, the second customer segment may be associated with a second retail space (e.g., store 304). As will be discussed in greater detail below, cognitive fashion inventory process 10 may generate an order to transfer or redistribute the plurality of fashion products from the first retail space to the second retail space after expiry of the first time period.

In some implementations, cognitive fashion inventory process 10 may derive 410 one or more transfer costs and/or times from one or more retail spaces for each customer segment. For example and in some implementations, cognitive fashion inventory process 10 may derive 410 or determine the cost of transferring the plurality of fashion products from a first retail space after the first time period to a second retail space. In some implementations, cognitive fashion inventory process 10 may access or interact with various shipping management systems to determine costs associated with transferring fashion products between retail spaces (e.g., stores and warehouses) at various times (e.g., after the expiry of the first time period and/or at various points during the second time period). In some implementations, cognitive fashion inventory process 10 may arrange or rank the plurality of customer segments (e.g., in the order of highest fashion-ability score first) and determine an optimal and/or relatively more advantageous transfer or fulfilment cost and time from a plurality of possible transfer costs and transfer times.

In some implementations and in response to deriving 410 the leading and lagging purchase behavior for each class segment, cognitive fashion inventory process 10 may determine 412 bid costs for keywords for each segment. For example, cognitive fashion inventory process 10 may interact with and/or communicate directly or indirectly (i.e., via an advertising system) with one or more of a demand-side platform and a supply-side platform. A demand-side platform may generally include a system that allows buyers of digital advertising inventory to manage multiple advertisement exchange and data exchange accounts through one interface. In some embodiments, an advertising system may receive information associated with an advertising opportunity on a website from the demand-side platform and/or may provide one or more bids to the demand-side platform for bidding on the advertising opportunity on a website (e.g., bids associated with digital advertisements to occupy advertising space on a website) based on the bid costs and keywords determined 412 by cognitive fashion inventory process 10. In this way, cognitive fashion inventory process 10 may interact with and/or communicate with demand-side platforms to provide cognitive and visual analytics to provide digital advertisements of relevant fashion products for rendering and/or to provide bids for digital advertisements of relevant fashion products via a demand-side platform. A supply-side platform may generally include a technology platform to enable web publishers to manage advertising space inventory and opportunities, fill the advertising space inventory with digital advertisements, and receive revenue.

In some implementations, cognitive fashion inventory process 10 may determine 414 bid costs for keywords for each customer segment and the respective conversion rates (i.e., rates of bids placed converted into sales). As will be discussed in greater detail below, cognitive fashion inventory process 10 may help facilitate markdowns and/or advertising bids by evaluating the costs for markdowns on fashion products versus the conversion costs associated with advertising bids.

Referring again to FIG. 2 and in some implementations, cognitive fashion inventory process 10 may include associating 212 the at least a subset of the plurality of fashion products with a future fashion impact event. For example and referring again to FIG. 6, cognitive fashion inventory process 10 may determine 608 a listing of one or more fashion impact events. For example, fashion impact events may include fashion-related events, movies, fashion shows, theatrical productions, musicals, etc. that may have an impact on fashion. In some implementations, cognitive fashion inventory process 10 may determine 608 a listing of one or more fashion impacts from a database of fashion impact events, from a data mining application configured to identify fashion events, and/or may receive a listing of fashion impact events via a user interface. It will be appreciated that the listing of fashion impact events may be determined 608 in a variety of ways.

In some implementations, cognitive fashion inventory process 10 may generate 610 a fashion-ability score for each fashion product associated with the one or more fashion impact events. As discussed above and as shown in FIG. 5, cognitive fashion inventory process 10 may generate 610 a fashion-ability score for a plurality of fashion products associated with the one or more fashion impact events. For example, cognitive fashion inventory process 10 may receive a plurality of images of fashion products associated with the one or more fashion impact events and generate the plurality of fashion-ability scores to represent the plurality of fashion products associated with the one or more fashion impact events. In some implementations, the one or more fashion impact events may impact the fashion-ability scores of other fashion products. For example, a fashion show which introduces a new style of clothing may increase the fashion-ability scores for that style of clothing. As such, the ability to quickly and efficiently ship the fashion products with the new style of clothing to retail spaces with customer segments who have a demand for those fashion products (i.e., by the fashion-ability score) may allow retailers to more quickly meet customer demand and/or reduce the cost of shipping fashion goods in response to fashion impact events.

In some implementations, cognitive fashion inventory process 10 may derive 612 the spectral frequency and period lag effect on different events. For example, many algorithms for spectral frequency use a Fourier transformation to derive a spectral frequency and period lag effect on different fashion events. The best lag may be computed by taking correlation of primary time series with that of lead/lagged of a secondary time series and the lag/lead with the highest correlation may be considered as the lag/lead between the effects.

In some implementations, cognitive fashion inventory process 10 may obtain 614 a sales trend for each fashion-ability score group. In some implementations, cognitive fashion inventory process 10 may obtain 616 a base forecast for each fashion-ability score group. In some implementations, cognitive fashion inventory process 10 may obtain 618 a correction factor and revised forecast based upon, at least in part, the one or more fashion impact events and/or the period lag effect.

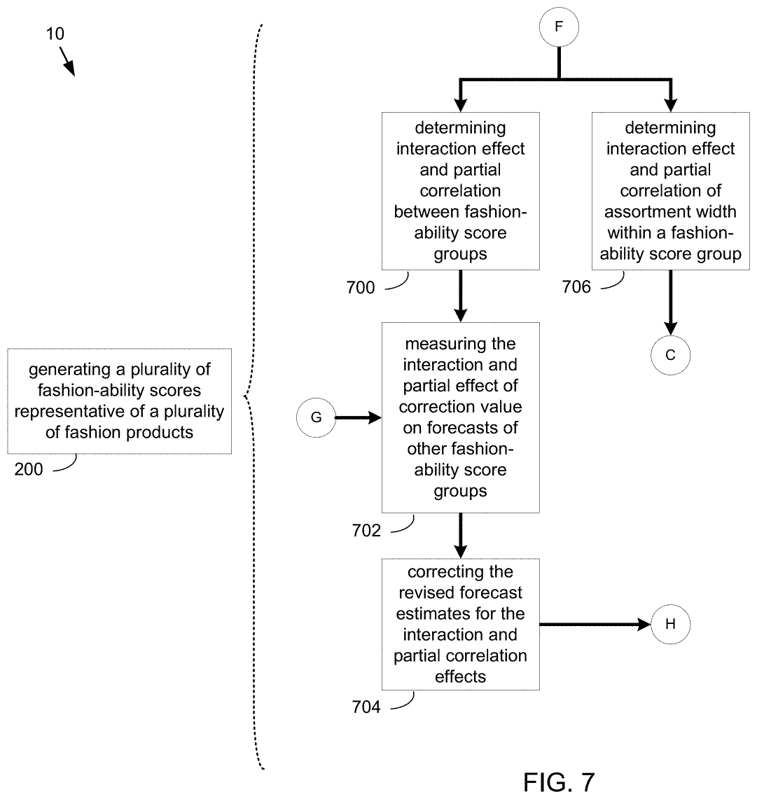

Referring also to FIG. 7 and in some implementations, cognitive fashion inventory process 10 may determine 700 an interaction effect and partial correlation effect between each of the plurality of fashion-ability score groups. In some implementations, cognitive fashion inventory process 10 may measure 702 the interaction effect and the partial correlation effect of correction value on forecasts of other fashion-ability score groups. In some implementations, cognitive fashion inventory process 10 may correct 704 the revised forecast estimates for the interaction effect and partial correlation effects. In some implementations, cognitive fashion inventory process 10 may determine 706 an interaction effect and a partial correlation effect of an assortment width within each fashion-ability score group. For example, the interaction event and partial correlation effect of an assortment width may describe the impact of purchasing at least one fashion product within a fashion-ability score group has on the purchase of another fashion product within the same fashion-ability group.

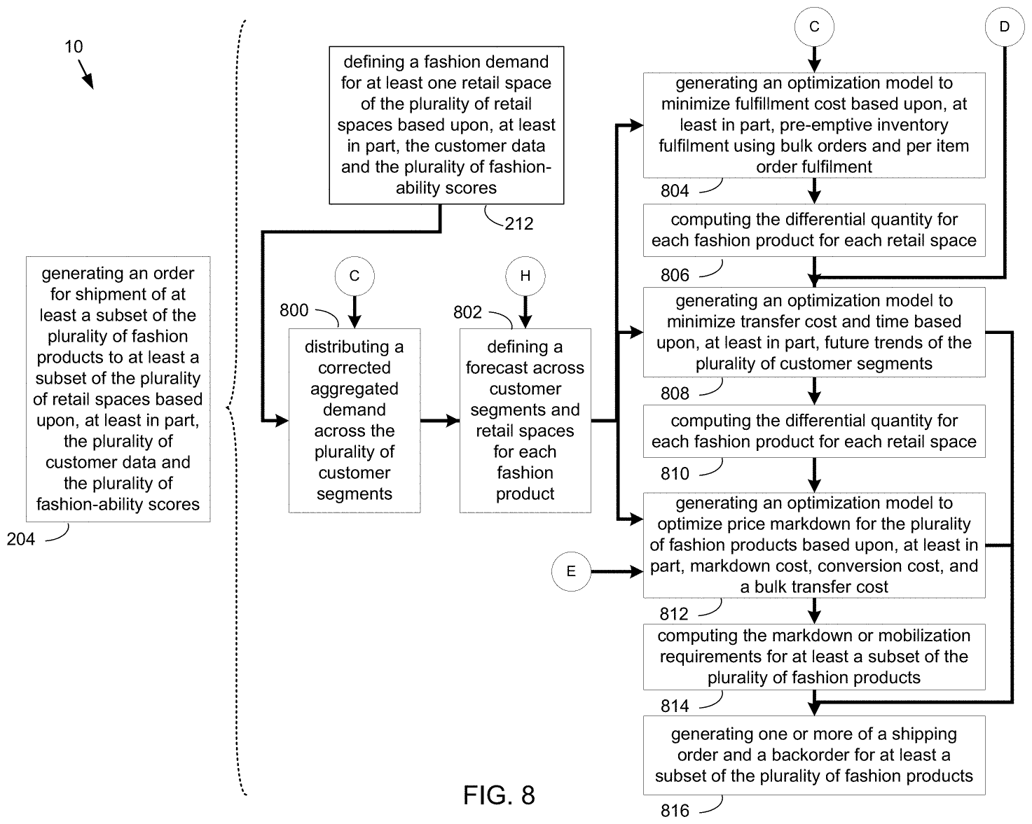

Referring also to FIG. 8 and in some implementations, cognitive fashion inventory process 10 may define 214 a fashion demand for at least one retail space of the plurality of retail spaces based upon, at least in part, the customer data and the plurality of fashion-ability scores. In some implementations, cognitive fashion inventory process 10 may distribute 800 a corrected aggregated fashion demand across the plurality of customer segments. In some implementations, cognitive fashion inventory process 10 may define 802 a forecast across the plurality of customer segments and retail spaces for each fashion product. The forecast may generally include a fashion demand for each customer segment of each retail space for each fashion product based upon, at least in part, the plurality of fashion-ability scores. For example, by defining the demand or forecast of each customer segment for each retail space with respect to fashion-ability scores and by defining the demand or forecast of each fashion product group to the fashion-ability scores, the demand for each customer segment of each retail space may be defined 802 or determined based upon the same underlying fashion-ability scores. In this manner, a fashion demand may be defined 214 for at least one retail space of the plurality of retail spaces based upon, at least in part, the plurality of fashion-ability scores. In some implementations, the defined 214 fashion demand may include a quantity for each fashion product (e.g., per stock keeping unit (SKU)) for each retail space (e.g., stores 300, 302, 304, 306 and warehouses 308, 310) for a pre-defined period of time. In some implementations, the pre-defined period of time may be a pre-defined fashion product restocking period or inventory period (e.g., days, months, weeks, etc.) and/or a pre-defined demand period.

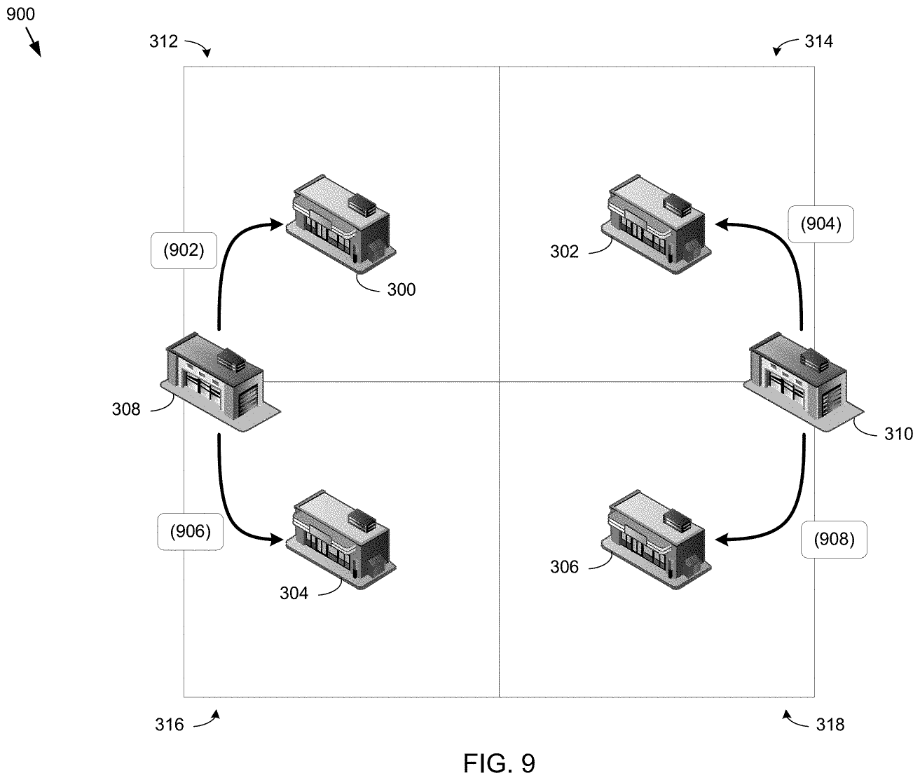

In some embodiments, cognitive fashion inventory process 10 may generate 204 an order for shipment of at least a subset of the plurality of fashion products to at least a subset of the plurality of retail spaces based upon, at least in part, the plurality of customer data and the plurality of fashion-ability scores. Referring also to FIG. 9 and as discussed above, cognitive fashion inventory process 10 may define 214 a fashion demand for at least one retail space of the plurality of retail spaces based upon, at least in part, the customer data and the plurality of fashion-ability scores. As discussed above, the fashion demand defined 214 by cognitive fashion inventory process 10 may include a quantity of fashion products (e.g., fashion products 902, 904, 906, 908) for a plurality of retail spaces (e.g., stores 300, 302, 304, 306). In some implementations, cognitive fashion inventory process 10 may generate an order for shipment of at least a subset of the plurality of fashion products (e.g., fashion products 902, 904, 906, 908) to at least a subset of the plurality of retail spaces (e.g., 300, 302, 304, 306) based upon, at least in part, the defined 214 fashion demand for each retail space. In some implementations, cognitive fashion inventory process 10 may provide the generated orders to e.g., a DOM system (e.g., DOM system 66).

For example, suppose cognitive fashion inventory process 10 generates 204 fashion-ability scores for a particular style of men's and women's hats. As discussed above, cognitive fashion inventory process 10 may assign 606 the men's and women's hats into one or more fashion-ability score groups and may obtain 614 a sales trend for each fashion-ability group. In this manner, cognitive fashion inventory process 10 may obtain 616 a base forecast or demand for the men's and women's hats of the fashion-ability score group. In some implementations, cognitive fashion inventory process 10 may define 206 a plurality of customer segments for each retail space based upon, at least in part, fashion products associated with a plurality of customers from customer data. With these customer segments and demand associated with the men's and women's hats, cognitive fashion inventory process 10 may define 214 a fashion demand (e.g., quantity) for the men's and women's hats for each retail space. In this manner, cognitive fashion inventory process 10 may generate 204 an order for shipment of the men's and women's hats (e.g., fashion products 902, 904, 906, 908) from a plurality of warehouses (e.g., warehouses 308, 310) to a plurality of retail spaces (e.g., 300, 302, 304, 306). In some implementations, the quantity of men's and women's hats may be unique to each retail space based upon, at least in part, the plurality of customer segments defined for each retail space.

As discussed above and in some implementations, defining 214 the fashion demand for the at least one retail space may include generating 216 an order for shipment of the at least a subset of the plurality of fashion products associated with the future fashion impact event to the at least a subset of the plurality of retail spaces based upon, at least in part, the future fashion impact event. In some implementations, cognitive fashion inventory process 10 may generate 216 an order for shipment of at least a subset of the plurality of fashion products associated with a future fashion impact event to at least a subset of the plurality of retail spaces.

Continuing with the above example, suppose a fashion impact event is identified and includes the release of a new style of men's and women's hats from a new film. In some implementations and as discussed above, cognitive fashion inventory process 10 may generate 610 a fashion-ability score for the men's and women's hats associated with the fashion impact dress (e.g., a higher fashion-ability score representative of the “trendiness” of the new style of men's and women's hats). In some implementations, cognitive fashion inventory process 10 may obtain 618 a correction factor to a base forecast for men's and women's hats based upon, at least in part, the new style of men's and women's hats with the same fashion-ability score or a fashion-ability score within a pre-defined fashion-ability score threshold. As such, cognitive fashion inventory process 10 may increase the quantity of these hats to have ordered in each retail space for customer segments associated with e.g., higher fashion-ability scores. In this manner, cognitive fashion inventory process 10 may generate 204 an order for shipment of the plurality of fashion products (e.g., fashion products 902, 904, 906, 908) from a plurality of warehouses (e.g., warehouses 308, 310) to a plurality of retail spaces (e.g., 300, 302, 304, 306).

In some implementations, cognitive fashion inventory process 10 may generate 204 an order for shipment of the men's and women's new style of hats before the fashion impact event. For example and in some implementations, cognitive fashion inventory process 10 may pre-emptively generate orders for shipments of fashion products prior to an associated fashion impact event. In some implementations, cognitive fashion inventory process 10 may generate 204 orders for shipments of fashion products so that the fashion products are in stock in the plurality of retail spaces before and/or in time for the fashion impact event. In this manner, cognitive fashion inventory process 10 may pre-emptively provide fashion products at the highest point in demand.

In some implementations, generating 204 the order for shipment of the at least a subset of the plurality of fashion products may include generating 218 one or more optimization models. For example, cognitive fashion inventory process 10 may help optimize not only how many fashion products should be ordered for shipping to a plurality of retail spaces, but cognitive fashion inventory process 10 may also provide optimization of when, how, and at what cost fashion products are shipped to a plurality of retail spaces. For example and referring again to FIG. 8, cognitive fashion inventory process 10 may generate 804 an optimization model to minimize and/or reduce fulfilment cost based upon, at least in part, pre-emptive inventory fulfilment using bulk orders versus per item order fulfilment. In some implementations and in response to generating 804 the optimization model to minimize and/or reduce fulfilment cost, cognitive fashion inventory process 10 may compute 806 a differential quantity for each fashion product for each retail space.

For example, suppose cognitive fashion inventory process 10 defines 212 a fashion demand for e.g., five men's suits of a particular fashion-ability score each e.g., week at a particular retail space (e.g., store 300). This may be based upon, at least in part, the base forecast obtained 616 for men's suits of that particular fashion-ability score for that customer segment of store 300. However, cognitive fashion inventory process 10 may generate 804 an optimization model to minimize and/or reduce fulfilment cost by utilizing bulk orders, cognitive fashion inventory process 10 may compute 806 a differential quantity by creating larger bulk orders instead of more frequent per week shipments. While an example with five men's suits being ordered each week has been described, it will be appreciated that orders for shipment of fashion products with various fashion demands may be optimized to minimize and/or reduce fulfilment cost within the scope of the present disclosure.

In some implementations, cognitive fashion inventory process 10 may generate 808 an optimization model to minimize and/or reduce transfer or shipping costs based upon, at least in part, future fashion demands of the plurality of customer segments. In some implementations and in response to generating 808 the optimization model to minimize and/or reduce transfer or shipping costs, cognitive fashion inventory process 10 may compute 810 a differential quantity for each fashion product for each retail space.

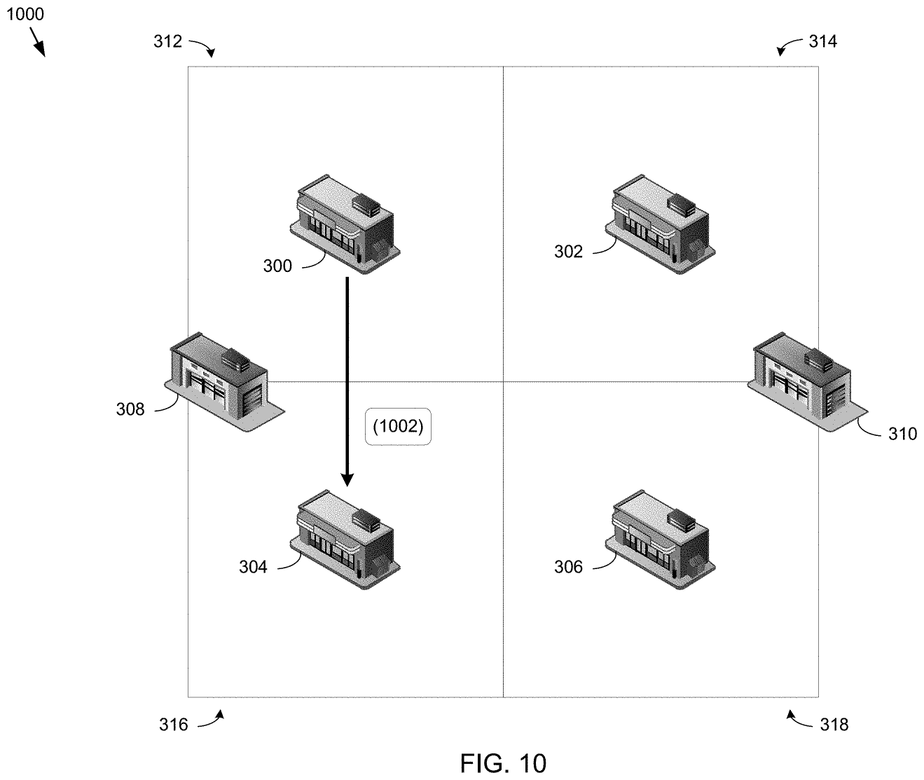

For example and referring also to FIG. 10, suppose cognitive fashion inventory process 10 defines 212 a fashion demand for e.g., ten women's dresses of a very high fashion-ability score during the first two months that the women's dresses are publicly available at a particular retail space (e.g., store 300). This may be based upon, at least in part, deriving 408 the leading and lagging purchase behavior for each customer segment of the plurality of retail spaces. For example, suppose a first customer segment associated with a first retail space (e.g., store 300) has demand for higher fashion-ability score dresses (e.g., fashion-ability score greater than 9) during the first two months of public availability. Further, suppose a second customer segment associated with a second retail space (e.g., store 304) has a demand for these same dresses once they have been on the market for over two months and/or after the first customer segment has already purchased these dresses. In this example, cognitive fashion inventory process 10 may generate 808 an optimization model to minimize and/or reduce transfer or shipping costs between these retail spaces after the e.g., two months have ended, cognitive fashion inventory process 10 may compute 810 a differential quantity for these dresses for each retail space.

In this manner, cognitive fashion inventory process 10 may generate 218 an order to redistribute the subset of fashion products from the first retail space to the second retail space after the first time period. For example, cognitive fashion inventory process 10 may redistribute the dresses (e.g., fashion product 1002) from the first retail space (e.g., store 300) to a second retail space (e.g., store 304) after the first time period (e.g., after the two months) to maintain a high demand and higher cost for the dresses. While an example with ten women's dressed being transferred from a first retail space to a second retail space has been discussed, it will be appreciated that orders for shipment of fashion products with various fashion demands may be optimized to minimize transfer or shipping costs between retail spaces within the scope of the present disclosure.

In some implementations, cognitive fashion inventory process 10 may generate 812 an optimization model to optimize price markdown for the plurality of fashion products based upon, at least in part, a markdown cost, a conversion cost, and/or a bulk transfer cost. In some implementations and in response to generating 812 the optimization model to minimize and/or reduce transfer or shipping costs, cognitive fashion inventory process 10 may compute 814 markdown and/or mobilization requirements for each fashion product for each retail space. As discussed above and in some implementations, cognitive fashion inventory process 10 may provide the markdowns to an advertising system to optimize bids for the plurality of fashion products.

As discussed above, embodiments of the present disclosure may work with different types of brick & mortar stores, online stores, and warehouses to coordinate the fulfilment and inventory across these channels. For example, cognitive fashion inventory process 10 may generate an order for shipment of a fashion product from an online order to be fulfilled from a nearby store instead of a warehouse based upon, at least in part, the one or more optimization models described above. As such, DOM systems may be improved by allowing greater flexibility in the fulfilment and pre-emptive ordering of fashion products for a retail space based upon, at least in part, the plurality of customer data and the plurality of fashion-ability scores.

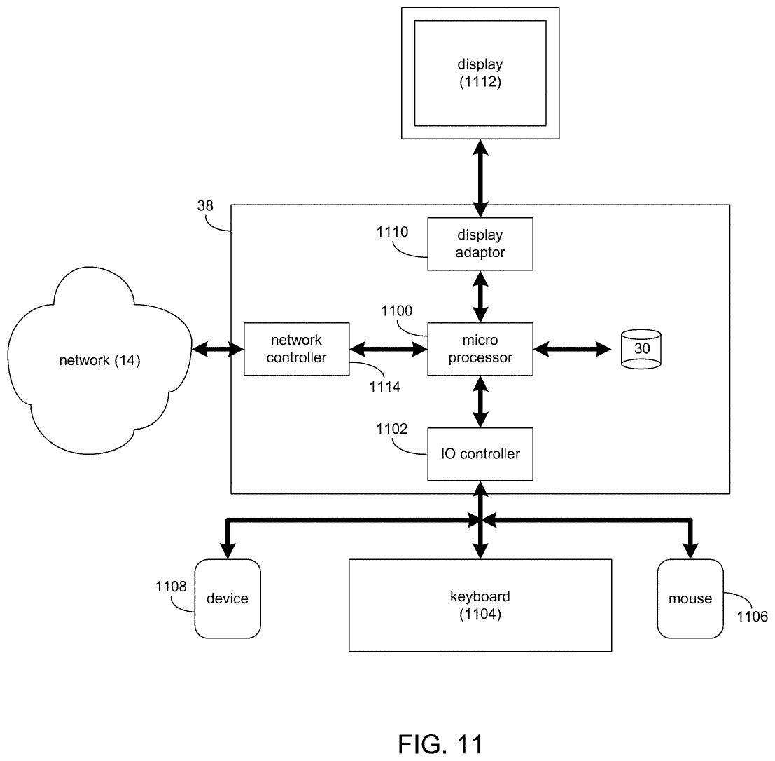

Referring also to FIG. 11, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, cognitive fashion inventory process 10 may be substituted for client electronic device 38 within FIG. 11, examples of which may include but are not limited to computing device 12 and/or client electronic devices 40, 42, 44.

Client electronic device 38 may include a processor and/or microprocessor (e.g., microprocessor 1100) configured to, e.g., process data and execute the above-noted code/instruction sets and subroutines. Microprocessor 1100 may be coupled via a storage adaptor (not shown) to the above-noted storage device(s) (e.g., storage device 30). An I/O controller (e.g., I/O controller 1102) may be configured to couple microprocessor 1100 with various devices, such as keyboard 1104, pointing/selecting device (e.g., mouse 1106), custom device (e.g., device 1108), USB ports (not shown), and printer ports (not shown). A display adaptor (e.g., display adaptor 1110) may be configured to couple display 1112 (e.g., CRT or LCD monitor(s)) with microprocessor 1100, while network controller/adaptor 1114 (e.g., an Ethernet adaptor) may be configured to couple microprocessor 1100 to the above-noted network 14 (e.g., the Internet or a local area network).

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
receiving, on a computing device, a plurality of customer data for a plurality of retail spaces;
generating a plurality of fashion-ability scores representative of a plurality of fashion products; and
generating an order for shipment of at least a subset of the plurality of fashion products to at least a subset of the plurality of retail spaces based upon, at least in part, the plurality of customer data and the plurality of fashion-ability scores.

2. The computer-implemented method of claim 1, further comprising:
defining a fashion demand for at least one retail space of the plurality of retail spaces based upon, at least in part, the customer data and the plurality of fashion-ability scores.

3. The computer-implemented method of claim 1, further comprising:
associating the at least a subset of the plurality of fashion products with a future fashion impact event; and
generating an order for shipment of the at least a subset of the plurality of fashion products associated with the future fashion impact event to the at least a subset of the plurality of retail spaces based upon, at least in part, the future fashion impact event.

4. The computer-implemented method of claim 1, wherein generating the order for shipment of the at least a subset of the plurality of fashion products includes generating one or more optimization models.

5. The computer-implemented method of claim 1, wherein the one or more optimization models are configured to optimize the shipment of the at least a subset of the plurality of fashion products to the at least a subset of the plurality of retail spaces based upon, at least in part, one or more of a minimum shipping cost, a minimum transfer cost, and a minimum markdown cost.

6. The computer-implemented method of claim 1, further comprising:
defining a plurality of customer segments based upon, at least in part, the plurality of customer data;
associating a subset of fashion products with a first customer segment and a first retail space for a first time period based upon, at least in part, the plurality of customer data and the plurality of fashion-ability scores; and
associating the subset of fashion products with a second customer segment and a second retail space for a second time period after the first time period based upon, at least in part, the plurality of customer data and the plurality of fashion-ability scores.

7. The computer-implemented method of claim 6, further comprising:
generating an order to redistribute the subset of fashion products from the first retail space to the second retail space after the first time period.

8. A computer program product comprising a non-transitory computer readable storage medium having a plurality of instructions stored thereon, which, when executed by a processor, cause the processor to perform operations comprising:
receiving a plurality of customer data for a plurality of retail spaces;
generating a plurality of fashion-ability scores representative of a plurality of fashion products; and
generating an order for shipment of at least a subset of the plurality of fashion products to at least a subset of the plurality of retail spaces based upon, at least in part, the plurality of customer data and the plurality of fashion-ability scores.

9. The computer program product of claim 8, wherein the operations further comprise:
defining a fashion demand for at least one retail space of the plurality of retail spaces based upon, at least in part, the customer data and the plurality of fashion-ability scores.

10. The computer program product of claim 8, wherein the operations further comprise:
associating the at least a subset of the plurality of fashion products with a future fashion impact event; and
generating an order for shipment of the at least a subset of the plurality of fashion products associated with the future fashion impact event to the at least a subset of the plurality of retail spaces based upon, at least in part, the future fashion impact event.

11. The computer program product of claim 8, wherein generating the order for shipment of the at least a subset of the plurality of fashion products includes generating one or more optimization models.

12. The computer program product of claim 11, wherein the one or more optimization models are configured to optimize the shipment of the at least a subset of the plurality of fashion products to the at least a subset of the plurality of retail spaces based upon, at least in part, one or more of a minimum shipping cost, a minimum transfer cost, and a minimum markdown cost.

13. The computer program product of claim 8, the operations further comprising:
defining a plurality of customer segments based upon, at least in part, the plurality of customer data;
associating a subset of fashion products with a first customer segment and a first retail space for a first time period based upon, at least in part, the plurality of customer data and the plurality of fashion-ability scores; and
associating the subset of fashion products with a second customer segment and a second retail space for a second time period after the first time period based upon, at least in part, the plurality of customer data and the plurality of fashion-ability scores.

14. The computer program product of claim 13, the operations further comprising:
generating an order to redistribute the subset of fashion products from the first retail space to the second retail space after the first time period.

15. A computing system including one or more processors and one or more memories configured to perform operations comprising:
receiving a plurality of customer data for a plurality of retail spaces;
generating a plurality of fashion-ability scores representative of a plurality of fashion products; and
generating an order for shipment of at least a subset of the plurality of fashion products to at least a subset of the plurality of retail spaces based upon, at least in part, the plurality of customer data and the plurality of fashion-ability scores.

16. The computing system of claim 15, wherein the operations further comprise:
defining a fashion demand for at least one retail space of the plurality of retail spaces based upon, at least in part, the customer data and the plurality of fashion-ability scores.

17. The computing system of claim 15, wherein the operations further comprise:
associating the at least a subset of the plurality of fashion products with a future fashion impact event; and
generating an order for shipment of the at least a subset of the plurality of fashion products associated with the future fashion impact event to the at least a subset of the plurality of retail spaces based upon, at least in part, the future fashion impact event.

18. The computing system of claim 15, wherein generating the order for shipment of the at least a subset of the plurality of fashion products includes generating one or more optimization models.

19. The computing system of claim 18, wherein the one or more optimization models are configured to optimize the shipment of the at least a subset of the plurality of fashion products to the at least a subset of the plurality of retail spaces based upon, at least in part, one or more of a minimum shipping cost, a minimum transfer cost, and a minimum markdown cost.

20. The computing system of claim 15, the operations further comprising:
defining a plurality of customer segments based upon, at least in part, the plurality of customer data;
associating a subset of fashion products with a first customer segment and a first retail space for a first time period based upon, at least in part, the plurality of customer data and the plurality of fashion-ability scores;
associating the subset of fashion products with a second customer segment and a second retail space for a second time period after the first time period based upon, at least in part, the plurality of customer data and the plurality of fashion-ability scores; and
generating an order to redistribute the subset of fashion products from the first retail space to the second retail space after the first time period.
